(19) United States
(12) Patent Application Publication
(10) Pub. No.: US 2010/0226714 A1
(43) Pub. Date: Sep. 9, 2010

(54) Screw-free release mechanism

(76) Inventors: Chi-Yen Chiang, Taipei City (TW); Ching-Sen Hu, Sinjhuang City (TW); Chia-Ho Wang, Taipei City (TW)

Correspondence Address: G LINK CO., LTD., 3550 BELL ROAD, MINOOKA, IL, 60447, US

(21) Appl. No.: 11/987,120

(22) Filed: Nov. 27, 2007

(30) Foreign Application Priority Data
Sep. 19, 2007 (TW) 096215734

(51) Int. Cl. F16B 1/00

(52) U.S. Cl. 403/325

(57) ABSTRACT

A screw-free release mechanism comprises a first article disposed with an elastic arm and a first guide unit in which the elastic arm is coupled to a first end of a releasing arm. A second end of the releasing arm is disposed with a buckling unit and the first guide unit guides a moving direction of the releasing arm. When the releasing arm is moved toward a first direction thereof, the elastic arm will be caused to deform to generate an elastic force pushing the releasing arm to move toward a second direction thereof; entire components of the releasing mechanism are few, the structure is simple, and the releasing arm can then be allowed to assemble conveniently onto an article without needing screws. Whereby, the assembly efficiency and the production yield factor of the release mechanism can be elevated so as to reduce the production cost.

### BACKGROUND OF THE INVENTION

1. Field of the Invention

The present invention relates to a release mechanism, and more particularly to a screw-free coupled elements locking release mechanism.

2. Description of Related Art

There are a variety of release mechanisms used for coupling between a base seat and a cover of an electronic device to allow the base seat to buckle the cover. For example, Taiwan Patent No. M273751 discloses a locking structure capable of providing a foldable electronic device with a locking effect. A cavity provided with a first hole and a second hole corresponding to the locking structure is disposed on the foldable electronic device, and an engagement hole corresponding to the first hole is disposed on the foldable electronic device thereby allowing a user to lock the foldable electronic device in a close state by means of the engagement of the locking structure.

Taiwan Patent No. 452322 discloses a screw-free buckling apparatus on a upper cover of a computer housing; the buckling apparatus comprises an concave housing, a turner and a hooking element; the concave housing is hooked and retained in a breach of the upper cover, the turner is axially coupled onto the concave housing and the breach by passing a mandrel through a plurality of pivoting sheets on a bottom thereof to allow the turner to be pulled by a force to turn and further to allow the hooking element and a retaining seat disposed on the rear of the computer housing to be released by a hooking part.

U.S. Pat. No. 6,731,580 discloses a disk unit with a dual release mechanism for releasing a cover retaining member; the disk unit comprises a loading portion used for receiving a record media, a main body unit comprising the loading portion and a cover rotatably attached to the main body unit and capable of moving between a closed position that covers the loading portion and a plurality of open positions that expose the loading portion.

### SUMMARY OF THE INVENTION

For reducing coupling components of a release mechanism to allow the release mechanism to be assembled and detached more easily so as to reduce the cost, the present invention is proposed.

The main object of the present invention is to provide a screw-free release mechanism, allowing components thereof to be reduced, a structure thereof to be simpler and screws to be exempted to enable a releasing arm set to be assembled on an article more conveniently and capable of elevating the assembly efficiency and the production yield factor of the release mechanism to reduce the production cost.

Another object of the present invention is to provide a screw-free release mechanism, allowing tools to be exempted while detaching a releasing arm convenient and capable of elevating the detaching efficiency of the release mechanism and not causing the damage of components to waste the resource.

For attaining to the objects mentioned above, the present proposes a screw-free release mechanism provided with a convenient assembling and detaching structure and used for allowing a first article to buckle or release a movable end of a second article; the mechanism comprises: the first article provided with an elastic arm and a first guide unit, a free end of the elastic being provided with a first retaining unit; and

a releasing arm, a first end and a second end thereof being respectively provided with a second retaining unit and a buckling unit;
wherein the first guide unit guides a moving direction of the releasing arm, the first retaining unit is coupled to the second retaining unit; when the releasing arm is moved toward a first direction thereof, the elastic arm is allowed to deform to generate an elastic force pushing the releasing arm toward a second direction thereof; entire components of the release mechanism are few, a structure thereof is simple; the releasing arm can be assembled on an article even if screws are exempted thereby being capable of elevating the assembly efficiency of the release mechanism and reducing the product cost.

### BRIEF DESCRIPTION OF THE DRAWINGS

The present invention can be more fully understood by reference to the following description and accompanying drawings, in which:

FIG. 1 is a perspective view, showing a release mechanism of the present invention;

FIG. 2 is a partly enlarged view, showing a coupling structure of a release mechanism of the present invention;

FIG. 3 is a schematic view, showing the release mechanism and a second article buckled thereby according to the present invention; and

FIG. 4 is a partly enlarged view, showing the release mechanism and a coupling structure of the second article buckled thereby according to the present invention.

### DETAILED DESCRIPTION OF THE PREFERRED EMBODIMENTS

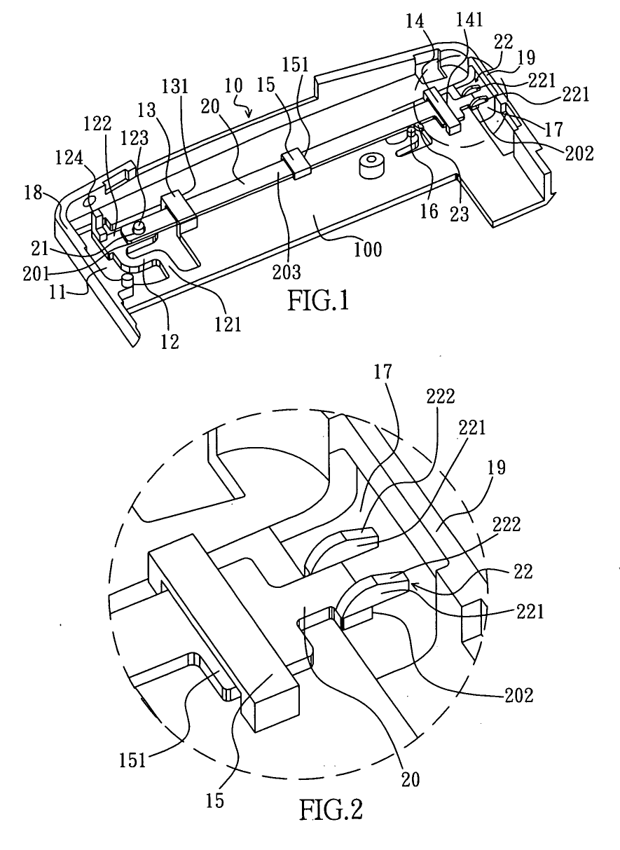

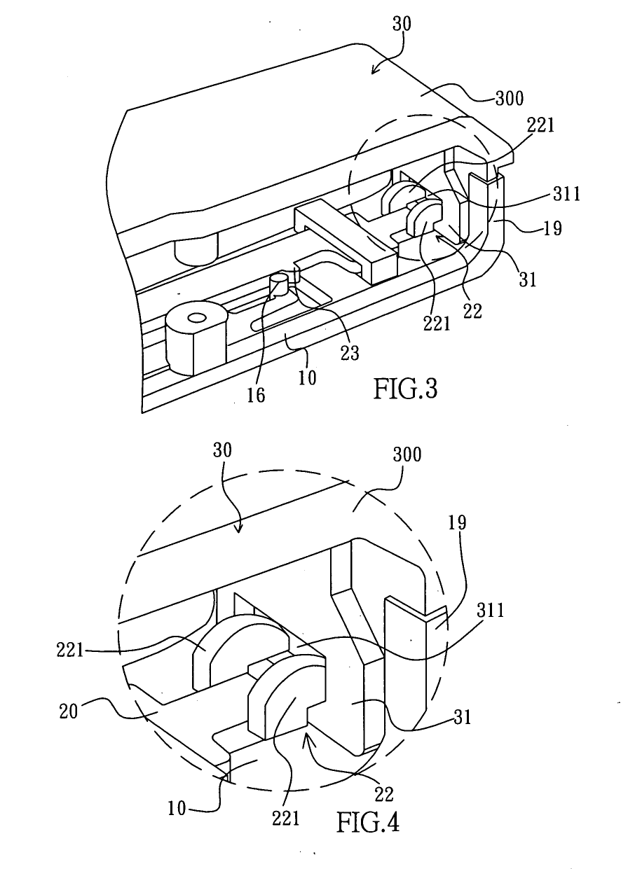

Please refer to FIGS. 1 to 4. A screw-free release mechanism is provided with a convenient assembling and detaching structure and used for allowing a first article to buckle or release a movable end of a second article; it comprises a first article 10 and a releasing arm 20 coupled thereto.

The first article 10 is disposed with a bottom plate 100, a first slot 11, an elastic arm 12, a first guide unit 13, a second guide unit 14, a third guide unit 15, a blocking post 16, a second slot 17, a first side frame 18 and a second side frame 19, in which the first slot 11 is disposed on the bottom plate 100 and close to the first side frame 18, the elastic arm 12 is positioned in the first slot 11, the fixed end 121 thereof is connected to the bottom plate 100 the free end 122 thereof is disposed with a first retaining unit 123 and a poking post 124. The elastic arm 12 is curved to increase a distance between the fixed end 121 and the free end 122 to allow the elastic arm 12 to be more flexible. The first retaining end 123 may be a retaining pin. The first, second and third guide units 13, 14 and 15 are respectively coupled to a upper side of the bottom plate 100 and respectively disposed with first, second and third grooves 131, 141 and 151. The blocking post 16 is projected upward from the upper side of the bottom plate 100 and the second slot 17 is positioned on a connection face of the bottom plate 100 and the second side frame 19.

A first end 201 and a second end 202 of the release arm 20 are respectively disposed with a second retaining unit 21 and a buckling unit 22. The second retaining unit 21 may be a retaining hole. The buckling unit 22 may be two hooks 221; a upper side of the hook 221 is disposed with an inclined side 222 inclined downward from a outer side thereof; a side of releasing arm 20 is further disposed with a tenon 23 projected outward.

When the release mechanism of the present invention is assembled, the first end 201 of the releasing arm 20 is allowed to move toward a first direction thereof and the second retaining unit 21 is allowed to couple to the first retaining unit 123 (e.g. the retaining hole is further put around the retaining pin as FIG. 1 shows) after being passed through the second guide groove 141, the third guide groove 151 and the first guide groove 131, and an assembly operation of the releasing arm 20 and the first article 10 is then completed; the assembly operation is very convenient and fast, in which the second guide groove 141, the third guide groove 151 and the first guide groove 131 are respectively adjacent to the second end 201, a middle 203 and the first end 201 of the releasing arm 20. At this time, the buckling unit 22 is adjacent to the second slot 17 and the tenon 23 is placed at one side of the blocking post 16. The blocking post 16 can stop the tenon 23 to limit an amount which the release arm 20 is moved toward the first direction thereof. When the releasing arm 20 is detached, the second retaining unit 21 is first caused to separate from the first retaining unit 123, the releasing arm 20 is further moved toward a second side thereof to cause the releasing arm 20 to be separated from the first, the second and the third guide grooves 131, 141 and 151 and a detaching operation of the releasing arm 20 can then be completed conveniently and fast.

Please refer to FIGS. 1 to 4 again. The screw-free release mechanism of the present invention is used for allowing a second article 30 and the first article 10 to be collected together or separated from each other. A movable end 300 of the second article 30 is disposed with a buckling unit 31 corresponding to the buckling unit 22; a buckling slot 311 is disposed on the buckling unit 31. After the first end 201 of the releasing arm 20 of the present invention is coupled to the elastic arm 12, the releasing arm 30 will be moved toward the first direction to drive the free end 122 of the elastic arm 12 to move toward the first direction of the releasing arm 20 when a lower end of the buckling unit 31 of the second article 30 exerts a force downward onto the inclined side 222 of the buckling unit 22 such that a deformation generates a force pushing the releasing arm 20 to move toward the second direction thereof; a first end of the buckling unit 22 is not placed at one side of the buckling slot 311 of the buckling unit 31 until a lower end of the buckling unit 31 is moved to a lower side of the buckling unit 22. At this time, the buckling unit 22 is not objected to the pushing force of the releasing arm 20, the buckling unit 22 is driven to move toward the first direction through a recovering force of the elastic arm 12 to enable the buckling unit 22 to be buckled in the buckling slot 311 so as to cause the movable end 300 of the second article 30 to be coupled to the second side frame 19 of the first article 10.

When the second end 202 of the releasing arm 20 is pushed to move toward the first direction of the releasing arm 20 from a place that the second slot 17 is located or a hook is used to stretch into the first slot 11 to hook the poking post 124 to move toward the first direction of the releasing arm 20, it causes the releasing arm 20 to move toward the first direction and further causes the buckling unit 22 to separate from the buckling slot 311, and the buckling unit 31 of the second article 30 can be released to allow the movable end 300 to be moved freely.

According to the screw-free releasing mechanism of the present invention, the components are few, the structure is simple and the releasing arm is then allowed to be assembled on an article even without screws; the assembly efficiency and the production yield factor of the release mechanism can be elevated, and the releasing arm can be conveniently detached without needing tools. Whereby, the detaching efficiency of the release mechanism can be elevated and the damage of the components and the waste of the resources will not be caused.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A screw-free release mechanism, provided with a convenient assembling and detaching structure and used for allowing a first article to buckle or release a movable end of a second article, comprising:
said first article, disposed with an elastic arm and a first guide unit; a free end of said elastic arm being disposed with a first retaining unit;
a releasing arm, a first end and a second end thereof being respectively disposed with a second retaining unit and a buckling unit;
wherein, said first guide unit guides said releasing arm in a moving direction; said first retaining unit is coupled to said second retaining unit; when said releasing arm is moved toward a first direction thereof, said releasing arm will be caused to deform to generate an elastic force pushing said releasing arm to move toward a second direction thereof.

2. The screw-free release mechanism according to claim 1, wherein said first article is disposed with a bottom plate; said bottom plate is disposed with a first slot; said first slot is used for receiving said elastic arm; a fixed end of said elastic arm is connected to said bottom plate.

3. The screw-free release mechanism according to claim 2, wherein a upper side of said bottom plate is connected to said first guide unit; said first guide unit is disposed with a first guide groove; said first guide groove receives said releasing arm and is adjacent to a first end of said releasing arm.

4. The screw-free release mechanism according to claim 3, wherein a upper side of said buckling unit is disposed with an inclined side inclined downward toward an outside direction thereof.

5. The screw-free release mechanism according to claim 4, wherein said buckling unit is two hooks; a upper side of said hook is disposed with said inclined side.

6. The screw-free release mechanism according to claim 5, wherein said first article is disposed with a first side frame; said first slot is adjacent to said first side frame.

7. The screw-free release mechanism according to claim 6, wherein a free end of said elastic arm is disposed with a poking post.

8. The screw-free release mechanism according to claim 7, wherein said first article is disposed with a second slot and a second side frame; said second slot is positioned on a connection face of said second side frame and said bottom plate; said retaining unit is adjacent to said second slot.

9. The screw-free release mechanism according to claim 8, wherein a upper side of said bottom plate is connected to a second guide unit; said second guide unit is disposed with a second guide groove; said second guide groove receives said releasing arm and is adjacent to a second end of said releasing arm.

10. The screw-free release mechanism according to claim 9, wherein a upper side of said bottom plate is connected to a third guide unit; said third guide unit is disposed with a third guide groove; said third guide groove receives said releasing arm and is adjacent to a middle of said releasing arm.

11. The screw-free release mechanism according to claim 10, wherein a upper side of said bottom plate is disposed with a raised blocking post; said releasing arm is disposed with a tenon; said blocking post is used for stopping said tenon to limit a moving amount of said releasing arm toward said first direction thereof.

12. The screw-free release mechanism according to claim 11, wherein said elastic arm is curved.
